(19) United States
(12) Patent Application Publication
(10) Pub. No.: US 2008/0004003 A1
(43) Pub. Date: Jan. 3, 2008

(54) Mobile device with detachable accessory

(76) Inventors: Thomas Wulff, North Patchogue, NY (US); Taheer Khazi, Central Islip, NY (US)

Correspondence Address: FAY KAPLUN & MARCIN, LLP, 15O BROADWAY, SUITE 702, NEW YORK, NY, 10038, US

(21) Appl. No.: 11/482,240

(22) Filed: Jun. 28, 2006

(51) Int. Cl. H04Q 7/20

(52) U.S. Cl. 455/425

(57) ABSTRACT

A device comprises a base unit including a first wireless communication arrangement. The device further comprises an accessory device mechanically coupled to the base unit and including a second wireless communication arrangement, the base unit and the accessory device communicating via the wireless communication arrangements.

### FIELD OF THE INVENTION

The present invention relates generally to mobile devices.

### BACKGROUND

Mobile devices often utilize an attachable accessory device. The accessory device communicates with a mobile device via a wired connection, such as one or more electrical contacts. Repeated use of the accessory device may cause the quality of the wired connection to decline. For example, the electrical contacts may be prone to corrosion, mechanical failure, electrical shorting and other problems.

### SUMMARY OF THE INVENTION

The present invention relates to a device comprising a base unit including a first wireless communication arrangement, and further comprising an accessory device mechanically coupled to the base unit and including a second wireless communication arrangement, the base unit and the accessory device communicating via the wireless communication arrangements.

The present invention also relates to accessory device comprising a mechanical arrangement configured to couple the accessory device to a base unit, and further comprising a wireless communication arrangement communicating with the base unit.

The present invention also relates to a device comprising a base unit including a first wireless communication means, and further comprising an accessory device coupled to the base unit via a coupling means and including a second wireless communication means, the base unit and the accessory device communicating via the wireless communication means.

### DESCRIPTION OF THE DRAWINGS

FIG. 1 shows an exemplary embodiment of a mobile unit according to the present invention.

FIG. 2 shows an exemplary embodiment of a mobile unit and a corresponding accessory device in a detached configuration according to the present invention.

FIG. 3 shows an exemplary embodiment of the mobile unit and the accessory device of FIG. 2 in an attached configuration according to the present invention.

FIG. 4 shows an exemplary embodiment of an accessory device according to the present invention.

FIG. 5 shows a second exemplary embodiment of an accessory device according to the present invention.

FIG. 6 shows an exemplary embodiment of a method according to the present invention.

### DETAILED DESCRIPTION

The present invention may be further understood with reference to the following description and the appended drawings, wherein like elements are referred to with the same reference numerals. The present invention describes a mobile device, such as a wirelessly enabled mobile unit (MU) (e.g., laser based scanners, image based scanners, RFID devices, PDAs, mobile phones, portable game consoles, laptops, etc.). While the exemplary embodiments of the present invention will be described with reference to mobile devices, those of skill in the art will understand that the present invention may be implemented with any device which is capable of wireless communication with an accessory device.

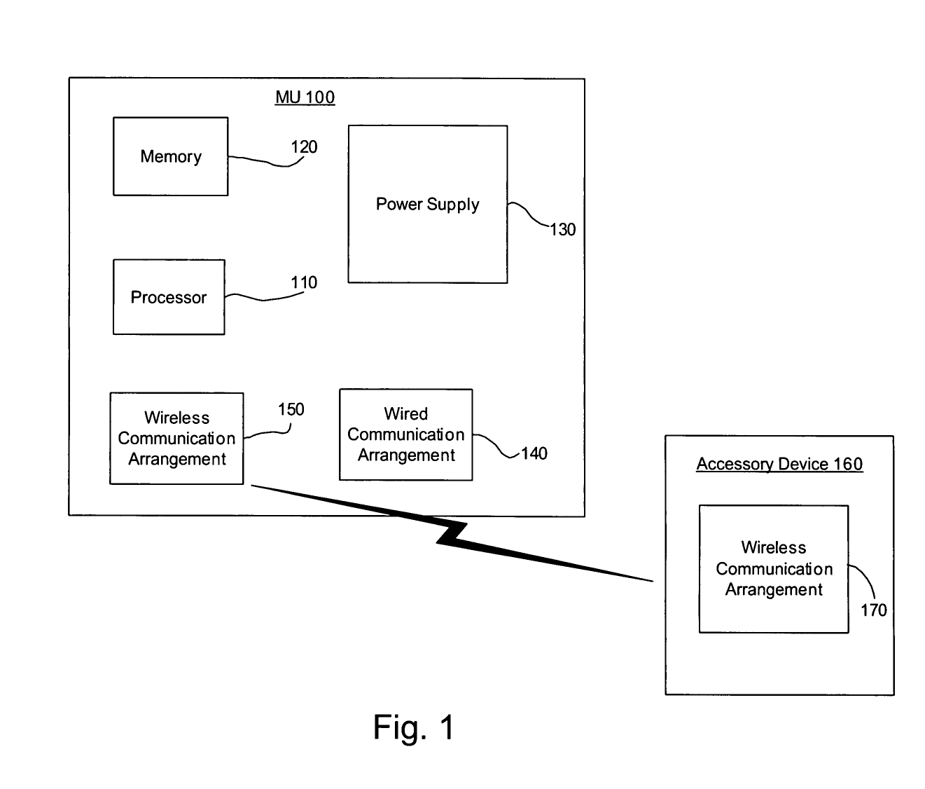

FIG. 1 shows an exemplary embodiment of an MU 100 according to the present invention. The exemplary embodiment is a block diagram representation showing various components which may be included in the MU 100. The MU 100 may include a processor 110, a memory 120, a power supply 130, a wired communication arrangement 140 and a wireless communication arrangement 150. The MU 100 may be utilized in any number of environments, including, but not limited to, a warehouse, an office, outdoors, etc. For example, a delivery person may utilize the MU 100 while on a delivery route, or to update inventory in the warehouse.

The memory 120 may be a random access memory, a read-only memory, a hard drive, etc. or any combination thereof. The memory 120 may comprise a database for storing instructions and/or data. For example, the memory may store an operating system and/or one or more software/firmware programs. According to an exemplary embodiment, the memory 120 may be programmed to allow the MU 100 to interact with an accessory device. For example, a provider of the MU 100 may install accessory-specific software onto the memory 120 when the MU 100 is manufactured, shipped to a user, etc. In other embodiments, the memory 120 may be user-programmable. For example, the user may write software for the accessory device using a software development program installed on the MU 100 and/or on another computing device (e.g., a personal computer, a laptop, etc.). Thus, software may be written directly on the MU 100 or downloaded from the other computing device.

The processor 110 may be any electrical arrangement which transmits and receives data and executes instructions. For example, the processor 110 may be a microprocessor, a combination of one of more integrated circuits (e.g., an application-specific integrated circuit), a programmable logic array, etc. The processor 110 bi-directionally communicates with the memory 120, the wired arrangement 140 and the wireless arrangement 150. The communication may occur via one or more data buses coupled to the processor 110. Thus, the processor 110 may execute instructions stored in the memory 120 and respond to instructions and/or data requests received via the wired and wireless arrangements 140, 150.

The power supply 130 provides power to the MU 100 and may include a battery, an AC-to-DC converter, and/or another conventional means for generating power. The power supply 130 may be configured to receive one or more inputs (e.g., 120 VAC, 5 VDC, etc.) and may provide one or more outputs (e.g., +5 V, −5 V, +12 V, −12 V, 0 V, etc.) to each of the components of the MU 100.

In the exemplary embodiment, the wired arrangement 140 includes one or more electrical contacts. For example, the contacts may comprise one or more sets of input/output (I/O) pins, such as a Universal Serial Bus (USB) port, a serial port, etc. The wired arrangement 140 may provide power and/or data transfer capabilities to a conventional (e.g., legacy) accessory device. An accessory device 160 is wirelessly coupled to the MU 100 via a wireless communication arrangement 170, which transmits and receives wireless data to/from the wireless arrangement 150. In one embodiment, the wireless arrangements 150, 270 is a radio frequency (RF) arrangement which utilizes a wireless communication protocol (e.g., a Bluetooth protocol, an IEEE 802.1x protocol, a WAN Protocol, etc.).

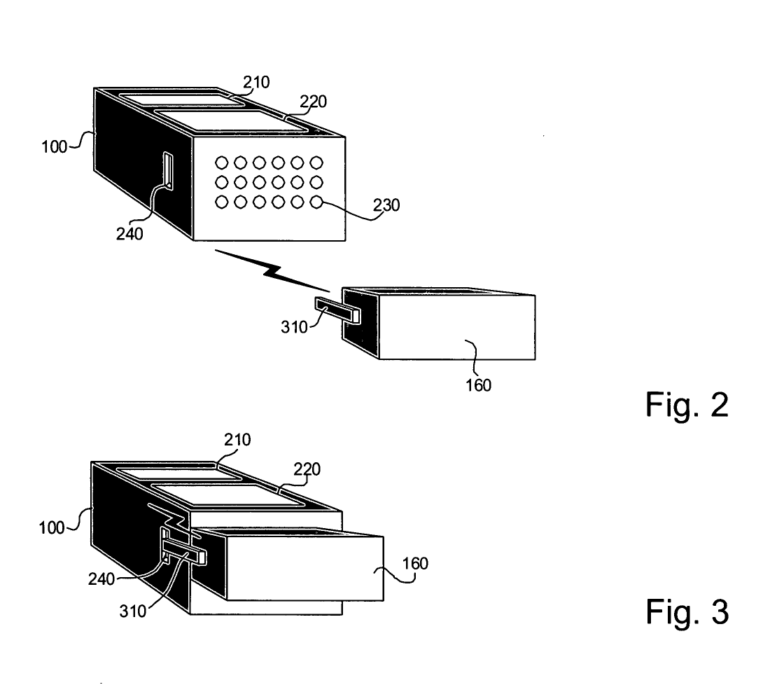

FIG. 2 shows an exemplary embodiment of the MU 100 and the accessory device 160 in a detached configuration. The MU 100 may include a display 210 (e.g., a liquid crystal display) and an input means (e.g., a keypad 220). The display 210 may be capable of receiving additional user input (e.g., touch-screen input). Thus, the user may enter input using the keypad 220 and/or the display 210. In other embodiments, other input devices (e.g., a touch-pad, a keyboard, etc.) may also be utilized.

One or more electrical contacts 230 may be disposed on a side (e.g., a proximal end) of the MU 100. The contacts 230 may comprise the wired arrangement 140 and may, as previously described, transfer power and/or data. However, in the exemplary embodiment, the MU 100 may not utilize the contacts 230 for communicating with the accessory device 160. That is, the accessory device 160 may communicate in an exclusively wireless manner with the MU 100. For example, the wireless arrangement 170 (shown in FIG. 1) may wirelessly couple the accessory device 160 to the MU 100 by communicating with the wireless arrangement 150. In addition, the accessory device 160 may be self-powered and/or receive power wirelessly (e.g., via induction) from the MU 100.

The MU 100 may include a receiving arrangement for detachably coupling to the accessory device 160. For example, the receiving arrangement may comprise one or more slots 240 selectively coupled to one or more corresponding interlocking tabs 310 located on a housing of the accessory device 160. The slots 240 may be shaped to complement the tabs 310, allowing the accessory device 160 to be snapped into place. Alternatively, tabs may be placed on a housing of the MU 100 while the receiving arrangement is disposed on the housing of the accessory device 160. Those of skill in the art will understand that the MU 100 may utilize any mechanism for detachably receiving the accessory device 160 including, but not limited to, hooks, clasps, adhesives, Velcro®, magnets, etc.

FIG. 3 shows an exemplary embodiment of the MU 100 and the accessory device 160 in an attached configuration according to the present invention. In the attached configuration, the slots 240 are mated to the tabs 310, which secure the accessory device 160 in place. A surface of the housing of the accessory device 160 may be flush with the contacts 230. Thus, although the contacts 230 may be unused, the housing of the accessory device 160 nevertheless protects the contacts 230 from physical exposure and potential damage. In other embodiments, the accessory device 160 does not cover the contacts 230 of the MU 100. Thus, the contacts 230 may be used to connect a separate (e.g., temporary) accessory device. It can be seen from the above described embodiments that the MU 100 and the accessory device 160 may have any shape when separated or attached to meet the form and function requirements of the device.

Although the exemplary embodiments described herein utilize an externally coupled accessory device, other embodiments may include accessory devices that are internally coupled to the MU 100. For example, in one embodiment, the MU 100 may include a compartment for receiving the accessory device, which may be placed therewithin by sliding, snapping, rotating, etc. Thus, the accessory device may be partially or fully received within the housing of the MU 100.

As shown in FIGS. 2 and 3, the accessory device 160 may be in wireless communication with the MU 100 in both the detached and the attached configurations. Thus, mechanical coupling of the accessory device 160 to the MU 100 may not be necessary in order to access a feature of the accessory device 160. In some embodiments, it may, however, be desirable to limit wireless communications between the accessory device 160 and the MU 100 while in the detached configuration. For example, transfer of data may be prevented unless the attached configuration is entered. This may be accomplished by, for example, having the MU 100 monitor (mechanical or electrical) the slot 240 location to determine if the accessory device 160 is attached. In another exemplary embodiment, the accessory device 160 monitors whether it is attached to the MU 100 and only enables the wireless communication arrangement 170 when it is determined that the accessory device 160 is attached to the MU 100.

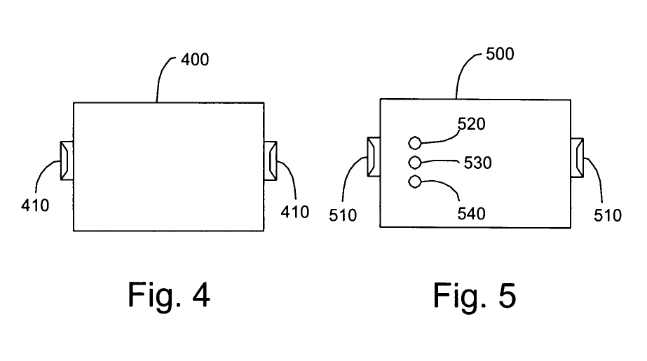

FIGS. 4-6 show exemplary embodiments of accessory devices 400, 500 and 600 according to the present invention. The embodiments are shown using rear views along a longitudinal axis of the accessory devices 400-600. The accessory devices 400-600 each include components (e.g., a wireless transmitter, a wireless receiver) for communicating wirelessly (e.g., via the wireless arrangement 150) with the MU 100, and may perform various functions. For example, the accessory devices 400-600 may be printers, bar code scanners, RFID readers, magnetic strip readers, audio devices, sensors, etc. The accessory devices 400-600 may be functionally similar. However, as will be described below, the accessory devices 400-600 may differ in a way each accessory device 400-600 interacts with the MU 100.

The accessory device 400 includes an attachment arrangement, such as, for example, one or more tabs 410. The accessory device 400 does not include any electrical contacts. Thus, the accessory device 400 communicates in an exclusively wireless manner with the MU 100. Wireless communication between the accessory device 400 and the MU 100 may commence in either the detached or the attached configurations.

The accessory device 500 includes one or more electrical contacts 520, 530 and 540, which deliver power to the accessory device 500 and are disposed proximally to one or more corresponding contacts of the MU 100 (e.g., the contacts 230) in the attached configuration. For example, the contact 520 may receive a first voltage (e.g., +5 V), the contact 530 may receive a second voltage (e.g., 0 V) and the contact 540 may receive a third voltage (e.g., −5 V). Although it may be preferable to avoid communication (e.g., data and/or power communication) via a mechanical arrangement, the contacts 520-540 may provide a supplementary source of power. For example, if a primary power source (e.g., a battery, a solar-cell, etc.) of the accessory device 500 fails, power received via the contacts 520-540 may allow the accessory device 500 to continue operating (e.g., wirelessly communicating with the MU 100).

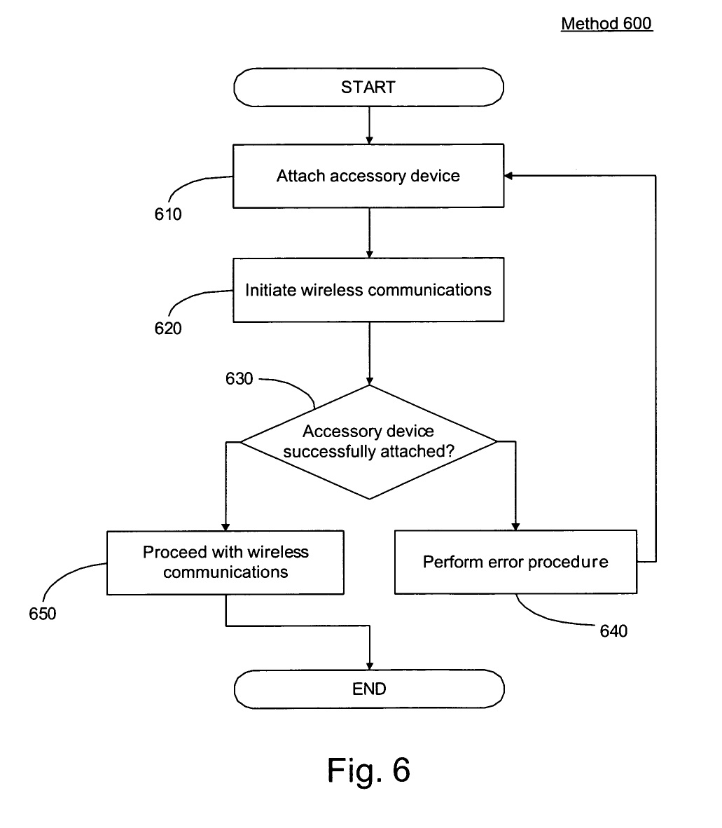

FIG. 6 shows an exemplary embodiment of a method 600 according to the present invention which will be described with reference to FIGS. 2 and 3. In an exemplary embodiment, an MU may communicate wirelessly with an accessory device in both the attached and the detached configurations. However, in certain instances, it may be desirable to restrict wireless communication while in the detached configuration. Reasons for restricting wireless communication may include, but are not limited to, ensuring that the accessory device has adequate power, ensuring that the accessory device is securely attached to prevent separation (e.g., moving out of communication range) from the MU and ensuring that a wired connection for the accessory device has been established. Thus, the method 600 may be applied to accessory devices 400 & 500. For example, if the accessory device is the accessory device 500, it may be desirable to provide power to the accessory device 500 before engaging in wireless communications. It may even be desirable to ensure that the accessory device 400 is attached prior to initiation of wireless communications, since physical separation between the accessory device 400 and the MU may result in signal loss and/or a failure to wirelessly communicate.

In step 610, a user attaches the accessory device 160 by coupling the tabs 310 to the slots 240. The user may confirm that the accessory device 160 is attached by visual inspection and/or physical testing (e.g., pulling on the accessory device 160). The user then initiates wireless communications (step 620). For example, if the wireless connection is a Bluetooth connection, the initiation may involve pairing the accessory device 160 to the MU 100. If the wireless connection is an 802.1x connection, the initiation may involve a handshake routine.

In step 630, the MU 100 determines whether the accessory device 160 has been successfully attached. The determination may be performed automatically. For example, the MU 100 may automatically detect the accessory device 160 via one or more mechanical and/or electrical sensors coupled to the contacts 230 and/or the housing thereof. Alternatively, the user may initiate the determination manually. In addition, although the accessory device 160 is physically attached to the MU 100, one or more electrical connections may not be established. For example, in an embodiment where the accessory device 160 utilizes one or more of the contacts 230, successful attachment may require that the contacts 230 be coupled to one or more corresponding contacts. The MU 100 may test each corresponding contact by, for example, transmitting a test signal through each contact 230. Successful attachment may be verified by a receiving of one or more response signals, a detecting of voltage and/or current using one or more voltage/current sensors coupled to the contacts 230, and other conventional techniques known to those skilled in the art.

In step 640, the accessory device 160 is not successfully attached and an error procedure is performed and the MU 100 blocks any further wireless requests from the accessory device 160. The error procedure may also include displaying an error message on the display 210, an audio alert, etc. or any other indicator which prompts the user to detach the accessory device 160 and repeat the method 700. Alternatively, if the accessory device 160 is successfully attached (step 650), the MU 100 proceeds with wireless communications (e.g., acknowledging a pairing request, negotiating encryption keys, transmitting configuration data, etc.).

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a base unit including a first wireless communication arrangement; and
an accessory device mechanically coupled to the base unit and including a second wireless communication arrangement, the base unit and the accessory device communicating via the first and second wireless communication arrangements.

2. The device according to claim 1, wherein the base unit includes a wired communication arrangement.

3. The device according to claim 2, wherein the accessory device communicates with the base unit simultaneously via the wired and the first wireless communication arrangements.

4. The device according to claim 2, wherein communication via the wired and the first wireless communication arrangements is independently selectable.

5. The device according to claim 1, wherein the accessory device is configured to communicate only when the mechanical coupling is verified.

6. The device according to claim 1, further comprising:
an attachment arrangement to perform the mechanical coupling of the base unit and the accessory device

7. The device according to claim 6, wherein the attachment arrangement includes a sensor indicating whether the mechanical coupling is successful.

8. The device according to claim 6, wherein the attachment arrangement is at least one of a snap-fit, a hook, a clasp, an adhesive, a Velcro® and a magnetic arrangement.

9. The device according to claim 1, wherein the first and second wireless communication arrangements communicate utilizing one of IEEE 802.1x protocol and a Bluetooth protocol.

10. An accessory device, comprising:
a mechanical arrangement configured to couple the accessory device to a base unit; and
a wireless communication arrangement communicating with the base unit.

11. The accessory device according to claim 10, wherein the accessory device communicates with the base unit exclusively via the wireless communication arrangement.

12. The accessory device according to claim 10, wherein the accessory device is configured to communicate only when the mechanical coupling of the mechanical arrangement and based unit is verified.

13. The accessory device according to claim 10, wherein the mechanical arrangement includes a sensor indicating whether the mechanical coupling is successful.

14. The accessory device according to claim 10, wherein the mechanical arrangement is at least one of a snap-fit, a hook, a clasp, an adhesive, a Velcro® and a magnetic arrangement.

15. The accessory device according to claim 10, wherein the accessory device receives power from the base unit.

16. The accessory device according to claim 10, further comprising:
a portable energy source arrangement providing power to the accessory device.

17. The accessory device according to claim 10, wherein the wireless communication arrangement communicates utilizing one of IEEE 802.1x protocol and a Bluetooth protocol.

18. A device, comprising:
a base unit including a first wireless communication means;
an accessory device coupled to the base unit via a coupling means and including a second wireless communication means, the base unit and the accessory device communicating via the wireless communication means.
